(19) United States
(12) Patent Application Publication
(10) Pub. No.: US 2026/0201748 A1
(43) Pub. Date: Jul. 16, 2026

(54) WINDOW SHADE WITH WANDS HAVING FUNCTION IDENTIFYING INDICIA AND METHOD OF USE THEREOF

(71) Applicant: Standard Textile Co., Inc., Cincinnati, OH (US)

(72) Inventors: Todd Steele, Fayetteville, OH (US); Richard M. Holbert, JR., Loveland, OH (US); Sara Arvidson Broadaway, Woodruff, SC (US)

(21) Appl. No.: 19/448,992

(22) Filed: Jan. 14, 2026

Related U.S. Application Data
(60) Provisional application No. 63/745,270, filed on Jan. 14, 2025.

(51) Int. Cl. E06B 9/78; E06B 9/42

(52) U.S. Cl. CPC E06B 9/78; E06B 9/42; E06B 2009/785

(57) ABSTRACT

An improved window shade includes a covering element operatively connected to an actuation mechanism configured to move the covering element, and a pair of window shade wands connected to the actuation mechanism to control movement of the covering element in different directions, to open and close visibility through the window. Each of the window shade wands includes a shaft extending between the actuation mechanism and a handle, and at least the first shaft of the first window shade wand includes an indicia differentiating the first shaft from the second shaft of the second window shade wand. The indicia guides the user to pull a correct one of the window shade wands for a desired movement operation of the covering element, thereby improving reliability and accessibility for different users operating the window shade. The indicia may take varying forms including red coloring along some or all of the first shaft.

### TECHNICAL FIELD

This application generally relates to the field of selectively-deployable window coverings, also known in the field as “window treatments.” More specifically, this application describes a window shade wand for actuating movement of a window covering, as well as a method of use thereof.

### BACKGROUND

For many, the process of raising or lowering a window shade or blind can be a frustrating trial-and-error process. Typically, a user interfaces with one of the window shade pull cords or chains and observes the effect. If the desired result (e.g., lowering or raising the window shade or blind) is achieved, then the interaction is complete. However, often the user initially chooses the wrong window shade or blind pull cord. A user who desires to raise the shade or blind may accidentally lower the shade or blind or vice versa. If the user initially chooses the wrong window shade or blind pull cord, a user must then interface with the other window shade or blind pull cord in order to achieve their initial desired result. This can be a frustrating experience. Particularly so if one desires to quickly close a window shade or blind during a stressful or emergency situation.

While some attempts have been made to improve the process for raising or lowering of a window shade or blind, users continue to struggle to identify the correct window shade or blind pull cord to interface with to achieve their desired result. This is especially true for children and users with limited vision or other disabilities. To that end, it would be desirable to provide an improved apparatus and/or method to guide a user to select the correct window shade or blind pull cord to achieve their desired result on the first attempt (e.g., lowering or raising the window shade or blind, respectively). To this end, improvements in reliability of operation and accessibility for all types of users are desired.

### SUMMARY

These technical problems in the known designs for window treatments and coverings are addressed by several embodiments of the present invention. According to a first set of embodiments of the present invention, a window shade is provided and is configured to selectively block visibility though a window. The window shade includes a covering element and a pair of window shade wands. The covering element is operatively connected to an actuation mechanism configured to move the covering element relative to the window. The pair of window shade wands includes a first window shade wand and a second window shade wand each connected to the actuation mechanism, such that a first window shade wand controls movement of the covering element in a first direction and a second window shade wand controls movement of the covering element in second direction. The first window shade wand includes a first shaft extending between a proximal end configured to be manipulated by a user and a distal end connected to the actuation mechanism. The second window shade wand includes a second shaft extending between a proximal end configured to be manipulated by a user and a distal end connected to the actuation mechanism. The first shaft of the first window shade wand includes indicia differentiating the first shaft from the second shaft of the second window shade wand, and thereby guiding the user to pull a correct one of the first and second window shade wands for a desired movement operation of the covering element. As such, a user can quickly and reliably identify the correct window shade wand to pull for a desired operation even in high-stress situations and even when the user is a child or has a visual impairment or other disability. The window shade therefore improves accessibility and functionality for many types of potential users and use cases.

In one embodiment, the indicia includes red coloring extending along at least a portion of the first shaft of the first window shade wand. Furthermore, the first shaft of the first window shade wand may be different in length than the second shaft of the second window shade wand, thereby providing another visual differentiation between proximal ends of the first and second window shade wands. More specifically, the first shaft is longer in length than the second shaft.

In another embodiment, each of the first and second window shade wands further includes a handle connected to the proximal end of the corresponding first or second shaft. In such an embodiment, the indicia may further include coloring extending along at least a portion of the first shaft of the first window shade wand, and the handle connected to the proximal end of the first window shade wand is at least partially colored to match the indicia.

The indicia may take on several different forms and may be also provided on the second shaft of the second window shade wand in further embodiments. For example, the indicia on the first and second shafts can include printed wording identifying different actuating functions performed by pulling on the proximal ends of the first and second window shade wands. Alternatively or additionally, the indicia on the first and second shafts includes printed symbols corresponding to a direction of movement of the window covering that is provided by pulling on the proximal ends of the first and second window shade wands. In another example, the indicia includes a multi-colored pattern applied to the first and second shafts, specifically with the multi-colored pattern on the first shaft being different than on the second shaft to differentiate actuation functions provided by pulling on each of the first and second window shade wands. Particularly when combined with providing the first and second shafts with different lengths from one another, the window shade wands quickly and reliably communicate via visual indication to a user which wand to pull for a desired movement of the window covering.

In some embodiments, the indicia is provided along a majority of a length of the first shaft of the first window shade wand. In other embodiments, the indicia is provided along only a portion of the first shaft of the first window shade wand, the portion being adjacent the proximal end. The length of the portion of the first shaft where the indicia is provided is within about 0.25 inch to about 1.00 inch.

In a further embodiment, the window covering is a roller shade configured to roll up and down from the actuation mechanism. The first and second shafts are each defined by cable-covering tubes that extend between the proximal and distal ends.

According to a related second set of embodiments of the present invention, a window shade wand assembly is provided and configured to operate an actuation mechanism of a window shade to move a covering element relative to a window. The assembly includes a first window shade wand including a first shaft extending between a distal end operatively connected to the actuation mechanism and a proximal end configured to be manipulated by a user. The first window shade wand also includes a handle connected to the proximal end of the first shaft configured to enable the user to pull on the first window shade wand to move the covering element in a first direction. The assembly includes a second window shade wand including a second shaft extending between a distal end operatively connected to the actuation mechanism and a proximal end configured to be manipulated by a user. The second window shade wand includes a handle connected to the proximal end of the second shaft configured to enable the user to pull on the second window shade wand to move the covering element in a second direction. The first shaft of the first window shade wand includes indicia differentiating the first shaft from the second shaft of the second window shade wand, and thereby guiding the user to pull a correct one of the first and second window shade wands for a desired movement direction of the covering element.

In one embodiment, the indicia includes at least one of: red coloring extending along at least a portion of the first shaft of the first window shade wand, printed wording identifying different actuating functions performed by pulling on the proximal ends of the first and second window shade wands, printed symbols corresponding to a direction of movement of the window covering that is provided by pulling on the proximal ends of the first and second window shade wands, and a multi-colored pattern applied to the first shaft.

In another embodiment, the first shaft of the first window shade wand is different in length than the second shaft of the second window shade wand, thereby providing another visual differentiation between proximal ends of the first and second window shade wands.

In a further embodiment, the indicia includes red coloring extending along at least a portion of the first shaft of the first window shade wand. The first shaft of the first window shade wand is longer in length than the second shaft of the second window shade wand, thereby providing another visual differentiation between proximal ends of the first and second window shade wands. Furthermore, the red coloring of the indicia is provided along only a portion of the first shaft of the first window shade wand, the portion being adjacent the proximal end and proximate the handle connected to the first window shade wand, and a length of the portion of the first shaft where the indicia may be optionally within about 0.25 inch to about 1.00 inch.

In accordance with a third set of embodiments of the present invention, a method is provided for using a window shade that is configured to selectively block visibility through a window with a moveable covering element. The method includes connecting a pair of window shade wands to an actuation mechanism of the window shade. A first window shade wand in the pair controls the actuation mechanism to move the covering element in a first direction to further block visibility through the window, and a second window shade wand in the pair controls the actuation mechanism to move the covering element in a second direction to increase or open visibility through the window. The method further includes providing an indicia on the first window shade wand differentiating the first window shade wand in visual appearance from the second window shade wand, thereby guiding a user to pull a correct one of the first and second window shade wands for a desired movement operation of the covering element. Each of the first and second window shade wands includes a handle and a shaft extending between a distal end connected to the actuation mechanism and a proximal end connected to the corresponding handle, and the indicia on the first window shade wand is positioned on the shaft of the first window shade wand proximate to the handle.

In one further embodiment of the method, the shaft of the first window shade wand is different in length than the shaft of the second window shade wand. The step of connecting the pair of window shade wands then includes positioning the first and second window shade wands such that the handles are located at different elevations relative to one another, thereby providing another visual differentiation between the first and second window shade wands that is indicative of their associated movement operation functions.

### BRIEF DESCRIPTION OF THE DRAWINGS

The accompanying drawings are included to provide a further understanding of the embodiments of the invention. These drawings are incorporated in and constitute a part of this specification. The drawings, together with the detailed description, serve to explain principles and operation of the various embodiments. Features and attributes associated with any of the embodiments shown or described may be applied to other embodiments shown or described.

FIG. 1 is a perspective view of a window covering including window shade wands, according to one embodiment of the present disclosure.

FIG. 2 is a front elevation view of the window shade wands of FIG. 1.

FIG. 3 is a rear elevation view thereof.

FIG. 4 is a right side elevation view thereof.

FIG. 5 is a left side elevation view thereof.

FIG. 6 is a top plan view thereof.

FIG. 7 is a bottom plan view thereof.

FIG. 8 is a perspective view of a window covering including window shade wands, according to another embodiment of the present disclosure.

FIG. 9 is a front elevation view of the window shade wands of FIG. 8.

FIG. 10 is a rear elevation view thereof.

FIG. 11 is a right side elevation view thereof.

FIG. 12 is a left side elevation view thereof

FIG. 13 is a top plan view thereof.

FIG. 14 is a bottom plan view thereof.

### DETAILED DESCRIPTION

In general, the present invention relates to an improved apparatus and method for operating a window shade or blind). As described above, there are drawbacks or shortcomings of existing solutions for improving the raising or lowering of a window shade or blind process. Advantageously, aspects of the apparatus and method of the present disclosure, described in greater detail below, address the drawbacks and shortcomings of existing solutions for improving the raising or lowering process of a window shade or blind. Particularly, the apparatus and method of the present disclosure uses easily-recognizable indicia to differentiate from a set of wands and thereby guide a user to select the correct window shade or blind wand to achieve their desired result. Other advantages and technical effects of the embodiments of this invention will become evident to one skilled in the art from the following description.

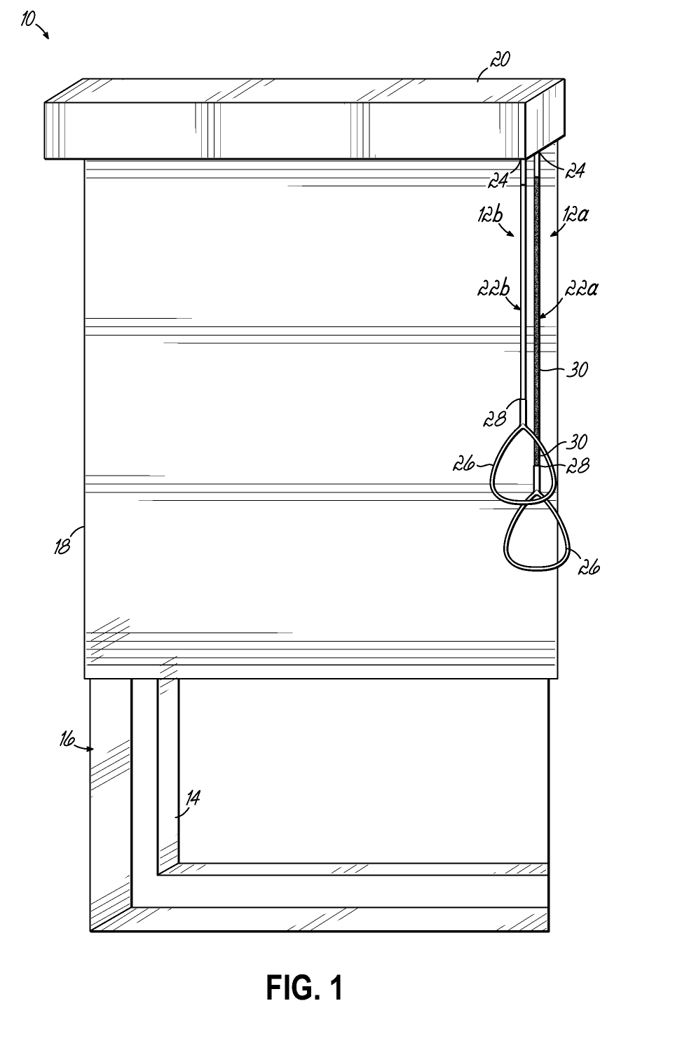

Referring to FIG. 1, an exemplary window shade 10 includes a pair of window shade wands 12a, 12b, according to a first embodiment. The exemplary window shade 10 is mounted on or above the window frame 14 of a window 16. The window shade 10 of this embodiment includes a roller shade 18 that extends in a downward direction. The selectively retractable roller shade 18 is configured to reduce or eliminate light that otherwise would pass through the window 16 and into a room, for example. An actuation mechanism 20 selectively raises and lowers the roller shade 18 based on the input of a user. In one example, the actuation mechanism 20 may be a known window covering actuator such as those available under the Newton® shade brand commercially available from Altex, of Montreal, Canada (and described, for example, in U.S. Patent No. 11,866,994). However, the specific constructional details of the actuation mechanism 20 is outside the scope of the present invention and will not be described in further detail herein.

A pair of window shade wands 12a, 12b are provided as shown in FIG. 1 to control the actuation mechanism 20. In the depicted embodiment, window shade wand 12a is longer in length than window shade wand 12b. It should be understood that the length of the window shade wands 12a, 12b may vary. For example, either wand 12a, 12b may be longer, shorter, or the same length as the other. Further, the length of the window shade wands 12a, 12b may vary depending on the height of the window 16 and/or the height of the intended user(s), for example. The pair of window shade wands 12a, 12b define a window shade wand assembly that can be used with varying types of window shades 10 to improve the functionality and accessibility thereof.

In the depicted embodiment, one of the window shade wands 12a controls the lowering of the roller shade 18. The other window shade wand 12b controls the raising of the roller shade 18. To this end, pulling generally downwardly on the first window shade wand 12a causes, via the actuation mechanism 20, the roller shade 18 to extend further from the actuation mechanism 20 and thereby deploy to cover more area of the window 16, whereas by contrast, pulling generally downwardly on the second window shade wand 12b causes, via the actuation mechanism 20, the roller shade 18 to retract or roll up at the actuation mechanism 20 and thereby uncover a larger area at the window 16. Though the depicted embodiment of the window shade 10 includes a roller shade 18 and a pair of window shade wands 12a, 12b, it should be understood that the window shade 10 could take on other forms. For example, the roller shade 18 could instead be a cellular shade, a Roman blind, a Venetian blind, or a similar shade or blind, for example (generically referred to as a covering element) – and these alternative types of covering elements are understood to move in a first direction for closing visibility through the window 16 and in a second direction for opening visibility through the window 16. Additionally, the number of the window shade wands 12a, 12b or the form of the window shade wands 12a, 12b could vary. For example, there may only be one window shade wand 12 instead of a pair of wands 12a, 12b. Further, the window shade wands 12a, 12b could take on an alternative form. The window shade wands 12a, 12b are designed to be ADA-compliant (Americans with Disabilities Act) and more reliable than conventional chain and cord-based designs, and as explained further below, are provided with additional feature to further enhance ease of use and ADA compliance/accessibility. Furthermore, this ease and reliability of operation is achieved with a manually actuated window shade 10, avoiding the expense and need for motorized actuators and more complex designs.

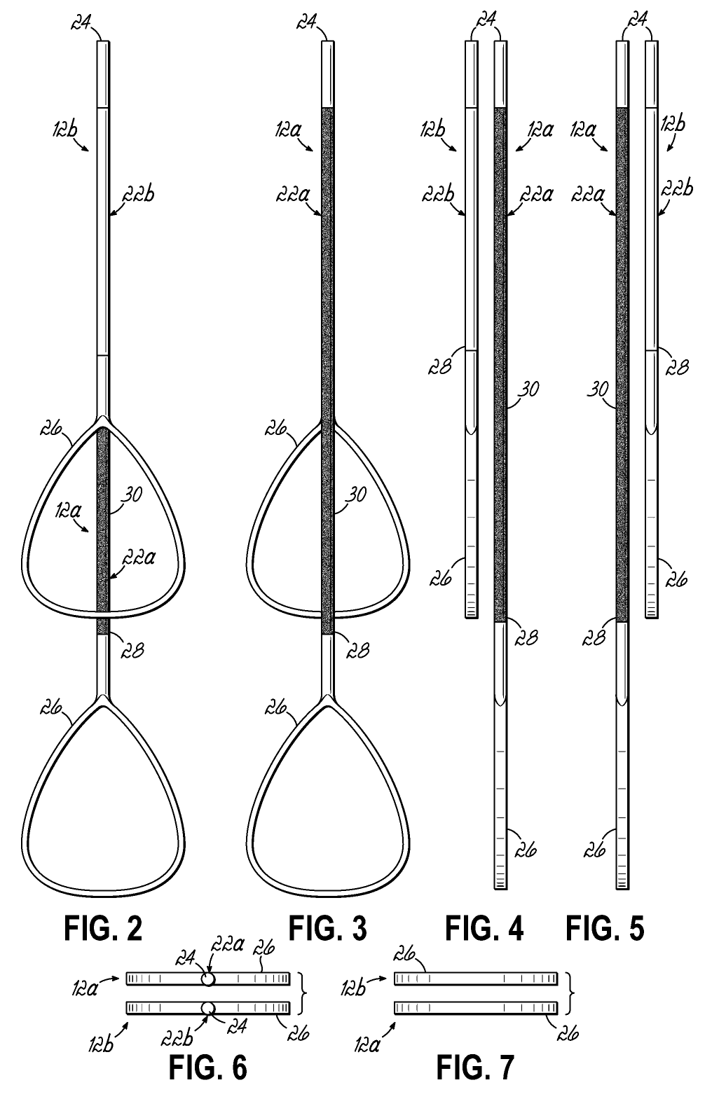

Referring now to FIGS. 2-7, the Figures show various views of this embodiment of the pair of window shade wands 12a, 12b. As noted above, the first window shade wand 12a controls the lowering of the roller shade 18 and the second window shade wand 12b controls the raising of the roller shade 18. Each of the window shade wands 12a, 12b includes a shaft 22a, 22b (also referred to individually and respectively as first shaft 22a and second shaft 22b below). The shaft 22a, 22b operatively connects at a distal end 24 of the shaft 22a, 22b to the actuation mechanism 20. It should be understood that the form of the shaft 22a, 22b could vary. For example, each shaft 22a, 22b could instead be a pull cord (or each shaft 22a, 22b may define, in some embodiments, a cable-covering tube extending along the length of the respective wand 12a, 12b). Each of the window shade wands 12a, 12b further include a flexible, teardrop-shaped handle 26. The handle 26 operatively connects to the shaft 22a, 22b at a proximal end 28 of the shaft 22a, 22b. It should be understood that the form of the handle 26 could vary. For example, the handle 26 could instead be a cylindrical grip that is attached to the proximal end 28 of the shaft 22a, 22b by adhesive or a friction fit, for example. It should further be understood that Applicant’s use of “handle” includes any mechanism or method of user interaction with the window shade wands 12a, 12b to control or activate the actuation mechanism 20 of the window shade 10. Further alternatively, the handle 26 could be excluded from the window shade wand 12a, 12b. A user interfaces with the handles 26 of the window shade wands 12a, 12b to operate the window shade 10 in this illustrated embodiment.

Advantageously, the first shaft 22a of the first window shade wand 12a that lowers the roller shade 18 is further differentiated from the second shaft 22b of the second window shade wand 12b that raises the roller shade 18 by the inclusion of an indicia 30 on the first shaft 22a. The indicia 30 on the first window shade wand 12a visually and clearly indicates to a user that the first window shade wand 12a lowers the roller shade 18 when pulled by the user. The indicia 30 is configured to guide a user to the first window shade wand 12a so that the user may more easily select the correct wand 12a to lower the roller shade 18 and avoid accidentally interfacing with the wrong window shade wand 12b to achieve their desired result of lowering the roller shade 18. Of course, this differentiation in the wands 12a, 12b also helps a user identify the correct second window shade wand 12b to pull on when it is desired to raise the roller shade 18.

In this regard, inclusion of the indicia 30 will assist children and/or those with limited vision or other disabilities, for example, in operating the window shade 10 by visually guiding a user to select the window shade wand 12a, 12b that aligns with their desired result (e.g., raising or lowering the roller shade 18). Such may be particularly advantageous during an emergency situation. In one example, during an active shooter situation identified on a school premises, a standard protocol is to lower the window shades in all classrooms so that no one can see into the classroom from the outside. During such an emergency situation, the indicia 30 on the first window shade wand 12a will guide the teacher or child in the classroom to the correct window shade wand 12a to quickly and correctly use to lower the roller shade 18. Thus, the indicia 30 on the first window shade wand 12a helps to reduce or eliminate confusion that can occur when operating a window shade 10 and save precious seconds during an emergency situation, in this one particular use scenario. Of course, the easier identification of the functions of each of the window shade wands 12a, 12b will save time and avoid user frustration in all use circumstances of the window shade 10.

With continued reference to FIG. 2-7, the indicia 30 may take on a number of forms. For example, the indicia 30 may be a particular color placed on at least a portion of the length of the first shaft 22a of the first window shade wand 12a. The color chosen may be red, in one example, even though the color is shown as a differentiator in grayscale shading in the drawing views. It should be understood that other colors could be used. Alternatively, the indicia 30 could be an alternative style of color contrast between the first shaft 22a and the second shaft 22b (of the second window shade wand 12b). For example, the first shaft 22a could be red and the second shaft 22b could be white. As shown by the shading provided on the first shaft 22a, the indicia 30 in this example extends over a majority of or all of the length of the first shaft 22a between the distal end 24 and the proximal end 28, and the length of the indicia 30 in this embodiment may be anywhere from 6 to 24 inches or more, depending on the height of the window 16 and the corresponding size of the window shade 10.

It should be understood that other colors could be used. Further alternatively, one or both of the shafts 22a, 22b of the window shade wands 12a, 12b could be multi-colored—with the specific multi-color featured on the first shaft 22a being understood to mean that the first window shade wand 12a causes the roller shade 18 to lower, and the different multi-color featured on the second shaft 22b being understood to mean that the second window shade wand 12b causes the roller shade 18 to raise. For example, the first shaft 22a could be striped in red and white, and the second shaft 22b could be striped in blue and white. It should be understood that other colors could be used.

Further alternatively, the indicia 30 could include (alone or in combination with colors noted above) printed wording on the shafts 22a, 22b of the window shade wands 12a, 12b. For example, the word “DOWN” or “LOWER” could be included on the first shaft 22a and the word “UP” or “RAISE” could be included on the second shaft 22b. It should be understood that alternative words could be used. Further alternatively, the indicia 30 could be printed symbols on the shafts 22a, 22b of the window shade wands 12a, 12b. For example, at least one downward pointing arrow could be printed on the first shaft 22a and at least one upward pointing arrow could be printed on the second shaft 22b. It should be understood that alterative symbols could be used. Although these various types of alternative indicia 30 (wording, symbols, etc.) are not shown in FIGS. 2-7, it will be understood that they would be present in the shaded area shown on the first shaft 22a and a corresponding area on the second shaft 22b. It may be desirable to position such types of indicia 30 more closely to the proximal ends 28 so as to be closer to the handles 26.

With continued reference to FIGS. 2-7, the indicia 30 could be included on the handles 26 of the window shade wands 12a, 12b alternatively or in addition to indicia 30 being included on the shafts 22a, 22b of the window shade wands 12a, 12b. It should be understood that all of the above-described variations of indicia 30 as applied to the shafts 22a, 22b of the window shades wands 12a, 12b could alternatively or additionally be applied to the handles 26 of the window shade wands 12a, 12b. For example, the handles 26 of the window shade wands 12a, 12b could include color(s), words, symbols, or other indicia 30. Regardless of the selected form or combination of types of indicia 30 used, this feature in combination with the longer length of the first shaft 22a provides multiple visual cues or indicators identifying the window shaft wand 12a that can be pulled to lower the roller shade 18.

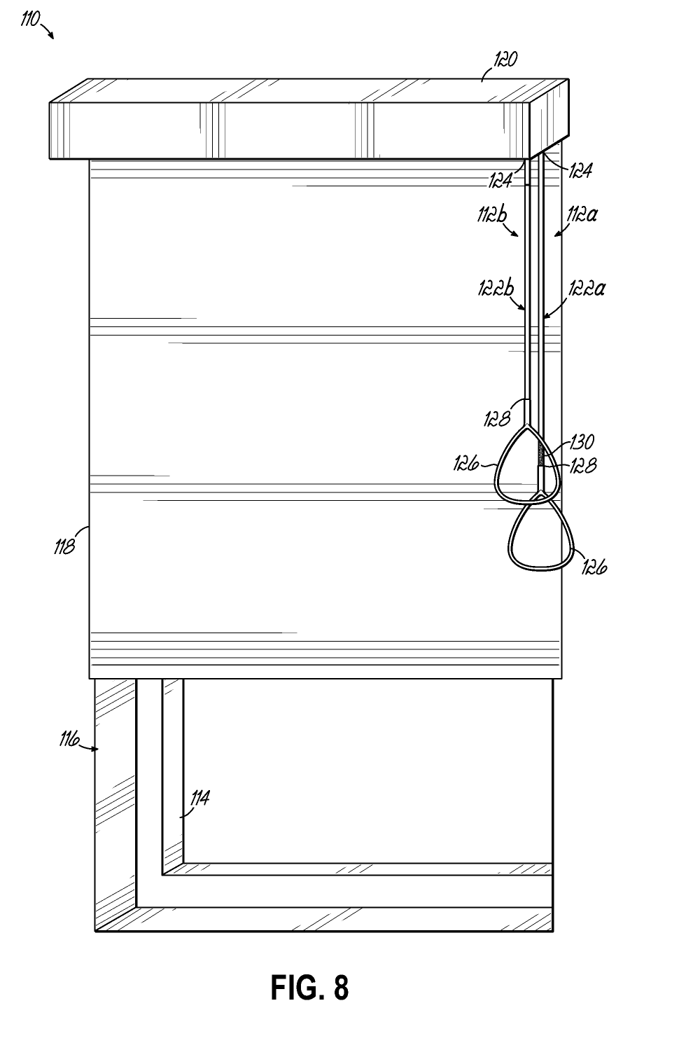

Now turning with reference to FIG. 8, a second embodiment of a window shade 110 in accordance with the present invention is shown. This window shade 110 is similar in many respects to the one shown and described above in connection with FIGS. 1-7, and similar elements are provided with similar reference numbers in this embodiment in the 100 series (e.g., the window shade is now labeled “110” instead of “10” and so on). The foregoing description of similar elements in the previous embodiment applies to this embodiment but for changes described in detail below.

To this end, window shade 110 is again positioned with a roller shade 118 that can extend or retract by an actuation mechanism 120 mounted above a window frame 114 of the associated window 116. A first window shade wand 112a and a second window shade wand 112b are connected to the actuation mechanism 120 and are configured to be pulled by a user to cause extension or retraction of the roller shade 118. Each of the window shade wands 112a, 112b again includes a shaft 122a, 122b that extends between a distal end 124 connected to the inputs of the actuation mechanism 120 and a proximal end 128 that carries a handle 126. The specific relative lengths and positioning of the window shade wands 112a, 112b and the specific arrangement of the handles 126 may be modified in other embodiments without departing from the scope of the present disclosure. As described previously, this type of window shade 110 is adapted to provide ease of use for moving the roller shade 118 between positions, but users may still not be able to identify (even in embodiments with different lengths of the shafts 122a, 122b) which of the handles 126 should be pulled to move the roller shade 118 in the direction intended.

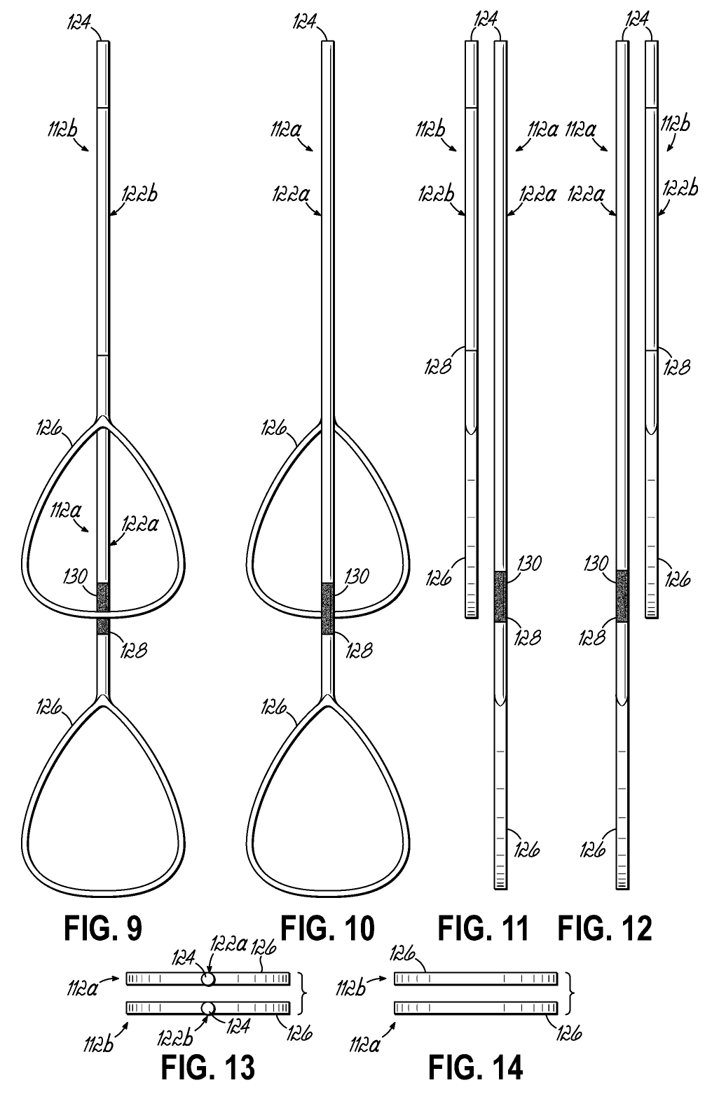

Consequently, this embodiment of the window shade 110 again provides an indicia 130 on the first shaft 122a of the first window shade wand 112a. The positioning and configuration of this indicia 130 is more readily visible in the detailed views of the first and second window shade wands 112a, 112b shown in FIGS. 9-14. With reference to these Figures, the indicia 130 is shown as a colored or color-contrasting portion of the first window shade wand 112a, and the colored portion is located at or proximate to the proximal end 128. The indicia 130 extends over a smaller length or portion of the first shaft 122a as compared to the previous embodiment. To this end, the indicia 130 extends over a length of about 0.25 inch to about 1.00 inch, for example. It will be understood that some variations of length (especially within this range) is possible, but the indicia 130 of this embodiment is only provided next to the handles 126 where a user will draw their attention when seeking to operate the window shade 110. This can be preferred when the remainder of the shafts 122a, 122b match an environmental color of the roller shade 118 or other parts of the window shade 110, while also simplifying the addition of the indicia 130 to the first window shade wand 112a. In other embodiments, the position of the shortened-length indicia may be moved upwardly on the first shaft 122a and can be located at any position including closer to the distal end 124. Though not shown in the schematic drawings, the handles 126 may optionally also be provided with similar coloring or color-coding to match or complement the indicia 130.

As with the prior embodiment, the indicia 130 may take different forms than a color (such as red) or a color contrast as compared to the second shaft 122b not containing the indicia 130. For example, a multi-color portion may be provided as the indicia 130 and/or provided in different color schemes on the two window shade wands 112a, 112b to differentiate these for the user. Alternatively, textual information such as words UP and DOWN can be printed as the indicia 130, or symbols such as directional arrows may be used. Moreover, combinations of these types of indicia can be provided even within the smaller length portion of the indicia 130 in case multiple indicators are deemed to improve ease of use and accessibility for the relevant users of the window shade 110. Regardless of the particular configuration defining the indicia 130, this element continues to help reduce or eliminate any confusion that can otherwise occur when operating the window shade 110 in a stressful or high-pressure situation, including the emergency situations as described earlier herein.

The various embodiments of the window shade 10, 110 described above improve the functionality and accessibility of these devices for different users and different use contexts, including high-stress situations where quick actuation of the roller shade 18, 118 is necessary. To this end, the provision of one or more indicia 30, 130 on the window shade wands guides the user to select the correct handle and wand to achieve their desired result (e.g., lowering or raising the window shade or blind). Such action to raise or lower the window shade 10, 110 can reliably be performed quickly even by users such as children or those with vision impairment or other disabilities, and this avoids the use of confusing bi-directional chain pulls and/or motorized actuation components to achieve this result. In the example provided where the indicia 30, 130 is provided as red coloring on the shaft and/or handle, it leads to a natural conclusion for users who may not even be familiar with the window shade system (e.g., pull the red one to close the window). In addition, the incorporation of the indicia 30, 130 in combination with the wand and handle-style actuation elements provides significant improvements in all consumer-desired factors, including reliability, cost, operational simplicity, and accessibility. As such, the window shades 10, 110 described herein are a superior design for most environments where window coverings are to be installed and used.

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A window shade configured to selectively block visibility through a window, the window shade comprising:
a covering element, in the form of a shade or a blind, operatively connected to an actuation mechanism configured to move the covering element relative to the window; and
a pair of window shade wands including a first window shade wand and a second window shade wand each connected to the actuation mechanism, such that the first window shade wand controls movement of the covering element in a first direction and the second window shade wand controls movement of the covering element in a second direction, the first window shade wand including a first shaft extending between a proximal end configured to be manipulated by a user and a distal end connected to the actuation mechanism, and the second window shade wand including a second shaft extending between a proximal end configured to be manipulated by a user and a distal end connected to the actuation mechanism,
wherein the first shaft of the first window shade wand includes indicia differentiating the first shaft from the second shaft of the second window shade wand, and thereby guiding the user to pull a correct one of the first and second window shade wands for a desired movement operation of the covering element.

2. The window shade of claim 1, wherein the indicia includes red coloring extending along at least a portion of the first shaft of the first window shade wand.

3. The window shade of claim 1, wherein the first shaft of the first window shade wand is different in length than the second shaft of the second window shade wand, thereby providing another visual differentiation between the proximal ends of the first and second window shade wands.

4. The window shade of claim 3, wherein the first shaft is longer in length than the second shaft.

5. The window shade of claim 1, wherein each of the first and second window shade wands further includes a handle connected to the proximal end of the corresponding first or second shaft.

6. The window shade of claim 5, wherein the indicia includes coloring extending along at least a portion of the first shaft of the first window shade wand, and the handle connected to the proximal end of the first window shade wand is at least partially colored to match the indicia.

7. The window shade of claim 1, wherein the second shaft of the second window shade wand also includes an indicia, and the indicia on the first and second shafts includes printed wording identifying different actuating functions performed by pulling on the proximal ends of the first and second window shade wands.

8. The window shade of claim 1, wherein the second shaft of the second window shade wand also includes an indicia, and the indicia on the first and second shafts includes printed symbols corresponding to a direction of movement of the window covering that is provided by pulling on the proximal ends of the first and second window shade wands.

9. The window shade of claim 1, wherein the second shaft of the second window shade wand also includes an indicia, and the indicia on the first and second shafts includes a multi-colored pattern applied to the first and second shafts, specifically with the multi-colored pattern on the first shaft being different than on the second shaft to differentiate actuation functions provided by pulling on each of the first and second window shade wands.

10. The window shade of claim 1, wherein the indicia is provided along a majority of a length of the first shaft of the first window shade wand.

11. The window shade of claim 1, wherein the indicia is provided along only a portion of the first shaft of the first window shade wand, the portion being adjacent the proximal end.

12. The window shade of claim 11, wherein a length of the portion of the first shaft where the indicia is provided is within about 0.25 inch to about 1.00 inch.

13. The window shade of claim 1, wherein the window covering is a roller shade configured to roll up and down from the actuation mechanism, and the first and second shafts are each defined by cable-covering tubes that extend between the proximal and distal ends.

14. The window shade of claim 13, wherein the indicia includes red coloring extending along at least a portion of the first shaft of the first window shade wand;
the first shaft of the first window shade wand is longer in length than the second shaft of the second window shade wand, thereby providing another visual differentiation between proximal ends of the first and second window shade wands;
each of the first and second window shade wands further includes a handle connected to the proximal end of the corresponding first or second shaft; and
the red coloring of the indicia is provided along only a portion of the first shaft of the first window shade wand, the portion being adjacent the proximal end and proximate the handle connected to the first window shade wand.

15. A window shade wand assembly configured to operate an actuation mechanism of a window shade to move a covering element relative to a window, the assembly comprising:
a first window shade wand including a first shaft extending between a distal end operatively connected to the actuation mechanism and a proximal end configured to be manipulated by a user, the first window shade wand further including a handle connected to the proximal end of the first shaft and configured to enable the user to pull on the first window shade wand to move the covering element in a first direction; and
a second window shade wand including a second shaft extending between a distal end operatively connected to the actuation mechanism and a proximal end configured to be manipulated by a user, the second window shade wand further including a handle connected to the proximal end of the second shaft and configured to enable the user to pull on the second window shade wand to move the covering element in a second direction,
wherein the first shaft of the first window shade wand includes indicia differentiating the first shaft from the second shaft of the second window shade wand, and thereby guiding the user to pull a correct one of the first and second window shade wands for a desired movement direction of the covering element.

16. The window shade wand assembly of claim 15, wherein the indicia includes at least one of: red coloring extending along at least a portion of the first shaft of the first window shade wand, printed wording identifying different actuating functions performed by pulling on the proximal ends of the first and second window shade wands, printed symbols corresponding to a direction of movement of the window covering that is provided by pulling on the proximal ends of the first and second window shade wands, and a multi-colored pattern applied to the first shaft.

17. The window shade wand assembly of claim 15, wherein the first shaft of the first window shade wand is different in length than the second shaft of the second window shade wand, thereby providing another visual differentiation between the proximal ends of the first and second window shade wands.

18. The window shade wand assembly of claim 15, wherein the indicia includes red coloring extending along at least a portion of the first shaft of the first window shade wand;
the first shaft of the first window shade wand is longer in length than the second shaft of the second window shade wand, thereby providing another visual differentiation between the proximal ends of the first and second window shade wands; and
the red coloring of the indicia is provided along only a portion of the first shaft of the first window shade wand, the portion being adjacent the proximal end and proximate the handle connected to the first window shade wand, and a length of the portion of the first shaft where the indicia is provided is within about 0.25 inch to about 1.00 inch.

19. A method of using a window shade that is configured to selectively block visibility through a window with a moveable covering element, the method comprising:
connecting a pair of window shade wands to an actuation mechanism of the window shade, wherein a first window shade wand in the pair controls the actuation mechanism to move the covering element in a first direction to further block visibility through the window, and a second window shade wand in the pair controls the actuation mechanism to move the covering element in a second direction to increase or open visibility through the window; and
providing an indicia on the first window shade wand differentiating the first window shade wand in visual appearance from the second window shade wand, thereby guiding a user to pull a correct one of the first and second window shade wands for a desired movement operation of the covering element,
wherein each of the first and second window shade wands includes a handle and a shaft extending between a distal end connected to the actuation mechanism and a proximal end connected to the corresponding handle, and the indicia on the first window shade wand is positioned on the shaft of the first window shade wand proximate to the handle.

20. The method of claim 19, wherein the shaft of the first window shade wand is different in length than the shaft of the second window shade wand, and the step of connecting the pair of window shade wands further comprises:
positioning the first and second window shade wands such that the handles are located at different elevations relative to one another, thereby providing another visual differentiation between the first and second window shade wands that is indicative of their associated movement operation functions.
